(19) United States
(12) Patent Application Publication
(10) Pub. No.: US 2006/0209803 A1
(43) Pub. Date: Sep. 21, 2006

(54) Output power weighting

(75) Inventors: Jari Rajaniemi, Kempele (FI); Harri Jokinen, Pertteli (FI)

Correspondence Address: DARBY & DARBY P.C., P.O. BOX 5257, NEW YORK, NY, 10150-6257, US

(73) Assignee: Nokia Corporation, Espoo (FI)

(21) Appl. No.: 11/369,629

(22) Filed: Mar. 7, 2006

(30) Foreign Application Priority Data
Mar. 7, 2005 (GB) 0504670.1

(51) Int. Cl. H04L 12/66

(52) U.S. Cl. 370/352

(57) ABSTRACT

A communication station for communicating with another communication station via at least two communications connections, the communication station being arranged to allocate transmit power to each of the at least two connections in dependence on connection quality, the communication station being arranged to: transmit data over a connection of a first type with a first transmit power level and transmit data over a connection of a second type with a second transmit power level; derive an indication of connection quality; determine if the connection quality is below a predetermined quality level; and in response to the connection quality being below the predetermined quality level, preferentially allocate transmit power to the connection of the first type, the quality level preferably being determined from a codec mode instruction for the transmit direction when a multi-rate speech codec is used.

### FIELD

The present invention relates to a method for controlling the transmit power of a dual transfer mode (DTM) mobile station. In particular, the present invention relates to a power allocation method in which the transmit power of a circuit-switched connection is prioritised over the transmit power of a packet-switched connection when the quality of an uplink connection is poor.

### BACKGROUND

A typical telecommunications system is shown in FIG. 1. The telecommunications system, shown generally at 100, comprises a mobile station 101 communicating with a base station 102. A plurality of base stations 102 are further connected to a mobile switching centre (MSC) 103. The mobile station and the base station communication via a communication link 105. The mobile station 105 includes a control unit 106 for controlling operation of the mobile station in accordance with both instructions generated internally by the mobile station and with instructions received externally e.g. from a base station 102. The area covered by each base station 102 is known as a cell and each mobile station generally communicates with the base station for the cell in which the mobile station is located.

In FIG. 1 only one mobile station 101 is shown. In reality each base station will be communicating with multiple mobile stations and the number of mobile stations communicating with a base station at any one time will fluctuate depending on which of the mobile stations has data to transmit. Since the amount of data that may be transmitted between mobile stations and a base station at any one time is limited by the available transmission bandwidth, there has to be a mechanism for allocating the available bandwidth between mobile stations so that the demands of each mobile station can be satisfied efficiently and fairly. This is achieved by dividing the available bandwidth into communication channels. When a mobile station has data to transmit it asks to be allocated a communication channel between itself and a base station.

The communication resources that are allocated to a mobile station depend on the type of connection that the mobile station requires. Two commonly used types of connection are circuit-switched connections and packet-switched connections. For circuit-switched connections, a dedicated communication channel is established for the duration of the transmission. This allows large amounts of data to be transferred with guaranteed transmission capacity, thus providing support for real-time traffic e.g. voice traffic. For connections involving bursts of random traffic, packet-switched connections utilise bandwidth more efficiently than circuit-switched connections by allowing one or more users to transmit data over a shared communication channel. In packet-switched connections, data to be transmitted is divided into standardised packets. Each packet may contain additional overhead information such as e.g. address, size, sequence and error-checking and correction information. Packet-switched connections therefore tend to be more robust than circuit-switched connections. However, they are not suitable for transmitting delay sensitive data. Therefore, the type of connection that a mobile station requires is determined by the kind of data that is to be transmitted over the connection.

One method for dividing up the available frequency spectrum into communication channels is frequency-division multiple access (FDMA). In this method, the available frequency spectrum is divided up into channels of a certain width, e.g. an available bandwidth of 20 MHz could be divided up into 200 communication channels of 100 kHz each. Therefore, a user communicating over an FDMA channel is allowed to use only part of the available frequency spectrum. Each frequency channel may be allocated to a different user or multiple users. Similarly, each user may be allocated resources on multiple channels.

Another method for dividing up the available frequency spectrum is time-division multiple access (TDMA). In TDMA, each user is allocated the entire available bandwidth, but only for a short period of time. During that time, the data is transmitted as fast as possible. However, unless the amount of data to be transmitted is particularly small, it is unlikely that it can all be transmitted in a single burst period. Therefore, a mobile station is allocated further burst periods at regular time intervals until all of its data has been transmitted. FIG. 2 shows a TDMA arrangement. Data is transmitted in frames (200-202), each having a frame period T_{f}. Each frame is subdivided into eight individual timeslots t₀-t₇ and each timeslot represents a communication channel. So in FIG. 2, the channel represented by timeslot 204 has been allocated to a particular mobile station and that mobile station transmits its data in the same timeslot of every TDMA frame. When the mobile station has finished transmitting its data, that channel, i.e. that particular timeslot, can be allocated to a different mobile station.

The available bandwidth can be utilised more efficiently by the allocation of half- or quarter rate channels. Examples of TDMA half-rate channels are shown in FIGS. 3 and 4. In FIG. 3, a half-rate channel is achieved by allocating one timeslot in every alternate frame to a single channel. So, timeslots 304 and 306 in frames 300 and 302 respectively form one communication channel. The corresponding timeslot 305 in frame 301 forms a different communication channel. In FIG. 3, the communication channel formed by timeslots 304 and 306 has been allocated to a connection and therefore data is transmitted during those timeslots. The average data rate of the connection over the half-rate channel is half that of a connection over full-rate channel, as the connection only transmits data every second frame.

An alternative method for implementing a half-rate TDMA channel is shown in FIG. 4. In this method, a single communication channel is allocated half a timeslot in every frame e.g. half-timeslots 404, 406 and 407. The remaining half of every timeslot may form a different communication channel e.g. half-timeslot 405. This timeslot allocation scheme again has the effect of halving the data rate available to a connection allocated to communication resources on a half-rate channel.

Obviously, quarter-rate channels can be implemented following the same principles outlined above, e.g. by allocating a quarter of a timeslot to a connection or by allocating one timeslot in every four frames to a connection. Channels having any desired data rate may be similarly implemented, i.e. the principle is not limited to half- or quarter-rate channels (although the usefulness of lower rate channels may be limited by practical considerations, such as the amount of data that typically needs to be transmitted over a connection). A telecommunications system may also limit half- or quarter-rate channels using different schemes (such as those illustrated in FIGS. 3 and 4).

FDMA and TDMA may also be combined to further utilise the available radio spectrum. FIG. 5 shows a multi-frame (or superframe) 500 according to this scheme. The available bandwidth of 25 MHz is first divided into 124 carrier frequencies, spaced 200 kHz apart. Each carrier frequency is then divided using a TDMA scheme, as shown in FIG. 4. Each multi-frame comprises a group of 26 TDMA frames 504, which are each divided into eight timeslots 501. Each burst period, i.e. each timeslot, lasts approximately 0.577 ms. As before, each timeslot 401 represents a channel. Each timeslot may be used for a traffic channel 502 or a control channel 503 etc.

The multi-frame arrangement can also support half-rate or quarter-rate channels. For example, FIG. 6 shows a multi-frame 600 that has been divided into two sub-channels (601, 602). Each sub-channel uses alternate frames, so that a half-rate channel is achieved by a single connection transmitting data every second frame. For example, in FIG. 6 the mobile station transmitting in timeslot 603 on sub-channel 0 transmits data in frames 0, 2, 4 etc. In frames 1, 3, 5 etc, that timeslot is used by a different mobile station using sub-channel 602.

For reduced rate channels to be usable, data compression techniques are needed to tailor the amount of data to be transmitted to the data rate of the channel that has been assigned to it. For voice traffic, the coding/decoding chip used to translate between analogue and digital signals is called a “codec”. More generally, the term “codec” may be used to define a compression/decompression algorithm. A codec may be implemented in hardware, software or in a combination of hardware and software.

When a user speaks into the microphone of a GSM mobile station, the speech signal is converted to a digital signal with a 13 bit resolution and is sampled at a rate of 8 kHz. The resulting 104 kHz signal is input into a GSM speech codec. The codec analyses the digital signal and generates a new signal that contains a number of parameters describing aspects of the voice. For example, some of the parameters generated by the codec are filter coefficients for the receiving device to use when filtering the received signal to reconstruct the original speech signal. The output data rate of the codec is dependent on its type. Examples of the output data rates of different codecs are contained in table 1 of FIG. 8. These are given for the purposes of example only and it should be understood that the scope of the term “codec” in the following description is not limited to these specific examples of commonly used codecs.

The full-rate codec is suitable for compressing data for transmission over a full-rate data channel. The enhanced full-rate codec (EFR) was introduced as processing power improved and gives a better quality of speech. The half-rate codec is suitable for transmission over a half-rate data channel. The remaining codecs listed in table 1 of FIG. 8 are adaptive multi-rate (AMR) codecs. AMR codecs use very similar computations to create different output rates. Using different codecs to generate different data rates is beneficial because it allows the coding rate to be modified according to the quality of the connection. For example, if the quality of the connection is poor, redundancy can be increased by reducing the coding rate, thereby allowing extra error correction coding to be introduced into the transmitted data. Therefore, in areas where signal quality is poor, the base station may instruct the mobile station to reduce the coding rate and increase redundancy. Similarly, where signal quality is good, the base station may instruct the mobile station to increase the coding rate as less error correction coding needs to be transmitted.

In addition to instructing the mobile station to change its coding rate, the base station may also instruct the mobile station to change its output power in response to changes in signal quality. For example, if the signal quality is poor, e.g. because the mobile station is approaching the boundary of a base station's coverage area, the base station will typically instruct the mobile station to increase its transmit power in response. Similarly, if the signal quality improves, the base station may instruct the mobile station to decrease its transmit power. Generally speaking, it is preferred to minimise transmit power as much as possible, in order to minimise interference with co-channel users.

Another consideration for keeping transmit power as low as possible is heat dissipation. It is preferable to keep heat dissipation to a minimum, in order to prevent electrical components of the mobile station from overheating. Another reason for minimising the transmit power of a mobile station is to keep the battery life to a maximum.

A GSM mobile station may transmit with full transmit power in during a circuit-switched call. However, in the interests of keeping transmit power to a minimum, the mobile station may reduce its transmit power when it is transmitting on multiple timeslots simultaneously. Table 2 of FIG. 9 lists typical reductions in output power that may be applied when the mobile station is transmitting on multiple timeslots. However, this system of power reduction has not been optimised for dual transfer mode (DTM) mobile stations.

DTM mobile stations are able to handle circuit-switched connections and packet-switched connections in parallel. DTM mobile stations also tend to use at least two transmit timeslots when transmitting data. Therefore, in keeping with the requirement for keeping transmit power to a minimum, the transmit power used for each timeslot is preferably reduced compared to the transmit power used for a normal speech service that utilises a single timeslot (see e.g. table 2 of FIG. 9). However, although this reduction of transmit power is necessary to minimise heat dissipation and SAR, it can compromise the quality of connections between a mobile station and a base station. This is particularly true for circuit-switched connections, which are especially vulnerable to poor signal conditions e.g. near cell boundaries. In a worst case scenario, a DTM call may be disconnected near the boundary of a cell.

Therefore, there is a need for an improved method of power allocation in DTM mobile stations.

### BRIEF SUMMARY

According to an embodiment of the present invention, there is provided a communication system having a communication station for communicating with another communication station via at least two communications connections, the communication station being arranged to allocate transmit power to each of the at least two connections in dependence on connection quality, the communication station being arranged to transmit data over a connection of a first type with a first transmit power level and transmit data over a connection of a second type with a second transmit power level, derive an indication of connection quality, determine if the connection quality is below a predetermined quality level and in response to the connection quality being below the predetermined quality level, preferentially allocate transmit power to the connection of the first type.

Preferably the connection of the first type is a circuit-switched connection and the connection of the second type is a packet-switched connection.

The communication station may be arranged to decrease the transmit power of the connection of the second type in response to the connection quality being below the predetermined quality level. The communication station may be arranged to decrease the transmit power of the connection of the second type in response to the connection quality being below the predetermined quality level, so as to maintain the total transmit power level of the communication station at or below a set level.

Preferably, the communication station comprises an active codec set containing at least two codecs and the communication station is arranged to encode data to be transmitted using a codec contained in the active codec set prior to transmitting the encoded data over a connection.

A communication system may preferably comprise a communication station according to an embodiment of the present invention and a controller for setting both the first transmit power level and the second transmit power level to be less than the transmit power level used for transmitting data over a single connection when the communication station is communicating with another communication station via only that connection.

The controller may be arranged to set the total transmit power level of the communication station.

The controller may be arranged to instruct the communication station to use a respective one of the codecs contained in the active codec set for encoding the data to be transmitted. The communication station may preferably be arranged to derive an indication of connection quality from the respective codec such that the connection quality is determined to be below the predetermined quality level if the respective codec is contained in a predetermined subset of the

Preferably the predetermined subset of the active codec set comprises the n lowest rate codecs of the active codec set, where n is a number less than the total number of codecs contained within the active codec set. According to one embodiment of the present invention, n is 1.

The controller may be contained within the communication station. Alternatively, the controller may be external to the communication station.

According to a second embodiment of the present invention, there is provided a method for allocating transmit power in a communication station, the communication station being arranged to communicate with another communication station via at least two communications connections and being arranged to allocate transmit power to each of the at least two connections in dependence on connection quality, the method comprising transmitting data over a connection of a first type with a first transmit power level and transmitting data over a connection of a second type with a second transmit power level, deriving an indication of connection quality, determining if the connection quality is below a predetermined quality level and in response to the connection quality being below the predetermined quality level, preferentially allocating transmit power to the connection of the first type.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 shows a telecommunications system;

FIG. 2 shows the frame structure of a full-rate TDMA connection;

FIG. 3 shows the frame structure of a half-rate TDMA connection;

FIG. 5 shows a multi-frame;

FIG. 6 shows a multi-frame arranged into two sub-frames;

FIG. 7 shows a flowchart illustrating a method according to an embodiment of the present invention;

FIG. 8 is a table of output data rates for codecs;

FIG. 9 is a table of typical reductions in output power that may be applied when the mobile station is transmitting on multiple timeslots; and

FIG. 10 is a table listing examples of commands that a mobile station might receive from a base station in a communications system that provides for adaptive power control.

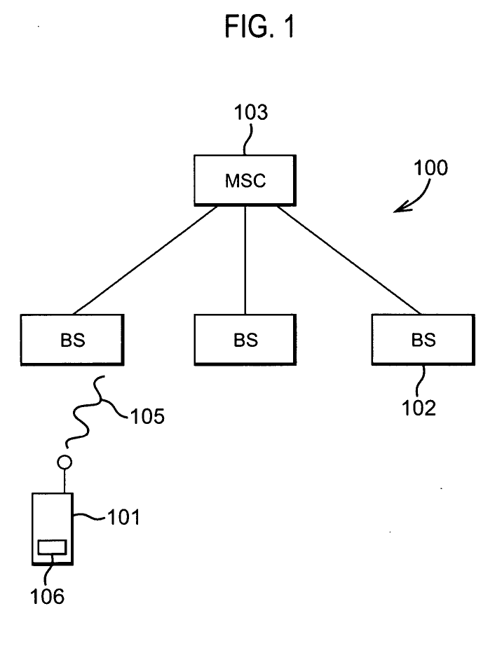

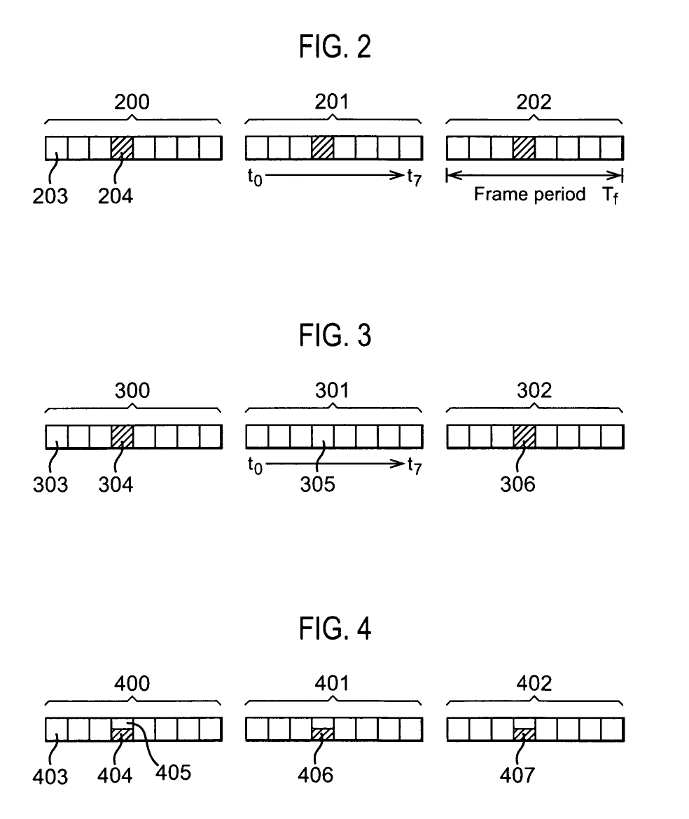

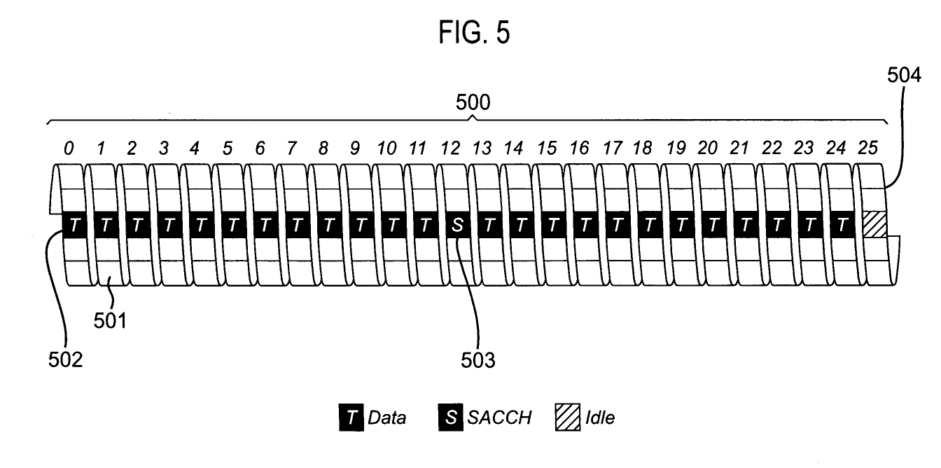

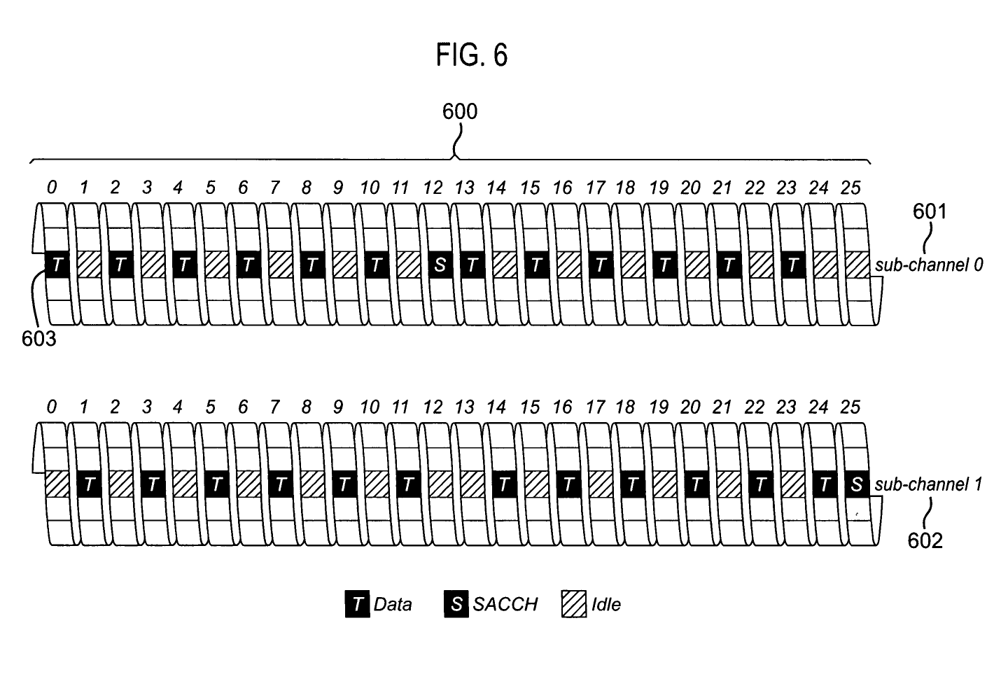

### DETAILED DESCRIPTION

Embodiments of the present invention provide a method for preferentially allocating transmit power of a mobile station to a circuit-switched connection when the mobile station is handling a circuit-switched connection and a packet-switched connection simultaneously and the signal quality is poor. Embodiments of the present invention are especially applicable to situations in which the maximum transmit power of the mobile station has been reduced because the mobile station is operating over multiple time slots. In such situations, the amount by which the mobile station can increase its transmit power in response to poor signal quality is restricted to the reduced maximum transmit power. As this restriction may be especially damaging to circuit-switched connections, the method according to the present invention may preferentially allocate transmit power to the circuit-switched connection. The transmit power of the packet-switched connection is correspondingly reduced, thereby maintaining the overall transmit power of the mobile station at the required power level. The preferential allocation of transmit power to the circuit-switched connection is preferably applied in situations where the signal quality is poor i.e. where there is real danger that the circuit-switched connection may be lost.

As discussed above, when a mobile station is transmitting over more than one timeslot it reduces its maximum transmit power to minimise heat dissipation. For example, the mobile station may reduce its maximum transmit power according to the scheme listed in table 2 of FIG. 9. Table 2 lists the reduction in maximum transmit power of the mobile station as a function of the number of timeslots that the mobile station has been assigned in the uplink connection. However, if the mobile station actually transmits on more timeslots than it has been assigned (e.g. due to a polling response) then the mobile station may reduce its transmit power as a function of the number of active timeslots in the uplink connection with the base station, rather than the number of assigned timeslots. Similarly, if the mobile station is not actually transmitting on all of the timeslots which it has been assigned, it may reduce its transmit power as a function of the actual number of timeslots being used rather than the number of timeslots it has been assigned. The output power reduction may also be static, i.e. dependent only on the number of assigned timeslots and independent of the number of active timeslots over which the mobile station actually transmits.

As a general principle, it is preferable to keep the transmit power of both mobile stations and base stations to the minimum necessary for maintaining the quality of the radio links, in order to reduce interference to co-channel users and to minimise heat dissipation and maximise battery life. However, when the quality of a radio link deteriorates, it is often necessary for the mobile station to increase its transmit power in order to maintain the connection with the base station. The quality of a radio link might deteriorate e.g. because the mobile station has moved towards the boundary of a cell. The base station typically instructs the mobile station to increase its transmit power when it detects that an increase in transmit power is required to maintain the quality of the radio link e.g. using power control information sent in a SACCH message block or in a dedicated signalling block.

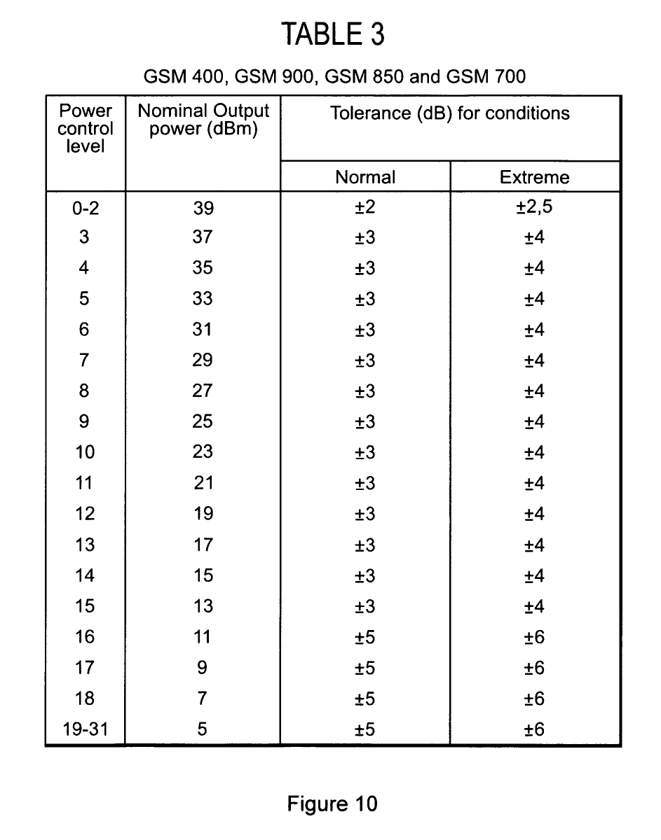

Depending on its class, each mobile station has a predetermined maximum transmit power and a predetermined lowest transmit power. The mobile station might typically be capable of varying its output power from its maximum transmit power down to its lowest transmit power in steps of e.g. 2 dBm. The mobile station may operate with the transmit power most recently commanded by the base station. For example, table 3 of FIG. 10 lists examples of commands that the mobile station might receive from a base station in a communications system that provides for adaptive power control. If the mobile station receives a power control command that instructs it to increase its transmit power beyond the maximum transmit power for the mobile station, then the mobile station may operate at its maximum transmit power level. Similarly, if the power control command received from the base station requests the mobile station to operate with a transmit power that it does not support, the mobile station may use the supported transmit power level that is closest to the requested level.

The base station may instruct the mobile station to use a particular transmit power for each connection and may also instruct the mobile station to use a particular average transmit power when the mobile station is transmitting over multiple connections (i.e. timeslots). Alternatively, the mobile station may determine the average transmit power and transmit power for individual connections.

If the mobile station is using multiple timeslots, then the maximum transmit power it can use on any of those timeslots is correspondingly reduced, as explained above. Therefore, the mobile station is restricted in how it can respond to commands to increase its transmit power from the base station. For example, if the maximum transmit power of a mobile station is 33 dBm and the mobile station is using two timeslots, then the maximum output power of the mobile station may be reduced to 30 dBm, using the power reductions listed in table 2 of FIG. 9. If the mobile station subsequently moves to the cell boundary, thus causing the signal quality to drop, the mobile station will be unable to increase its transmit power beyond the reduced level of 30 dBm. The reduced transmit power level may be insufficient to prevent the mobile station's connection with the mobile station from being dropped because of insufficient signal quality. This is especially true for circuit-switched connections, which are less robust than packet switched connections and are thus more vulnerable to poor signal quality. In particular, insufficient transmit power for a circuit-switched connection may result in poor audio quality, if not in a dropped call, while for packet-switched connections insufficient transmit power mainly results in decreased data throughput. The decreased data throughput for packet-switched connections is typically more acceptable to the user than poor audio quality over a circuit-switched connection, as so called “best effort services” are normally offered and these are very tolerant of variations in data throughput. Even if the insufficient transmit power results in full loss of data throughput for a packet-switched connection, this is generally less annoying for the user than a dropped call resulting from insufficient transmit power over a circuit-switched connection.

There are various methods by which the mobile station may determine that the signal quality on the radio link between the mobile station and the base station is poor. For example, the mobile station may itself measure the downlink signal quality, which it can use to determine that signal quality is poor. Alternatively, the mobile station may receive an indication from the base station that the signal quality is poor, e.g. a power control command instructing the mobile station to increase its transmit power. Both the mobile station and the base station may use various methods for determining signal quality e.g. signal strength, bit error rate (BER), signal-to-interference ratio (SIR), frame erasure etc. One particularly advantageous way in which an adaptive multi-rate (AMR) mobile station may determine that the quality of the radio link is poor is by using a codec command received from the base station.

The base station typically transmits a codec command to the mobile station every 40 ms. The codec command instructs the mobile station to use a particular codec mode from its active codec set. The codec to be used by the mobile station is determined by the quality of the uplink connection between the mobile station and the base station. Therefore, if the mobile station is instructed to use the most robust codec, i.e. one having the lowest speech coding bit rate, it knows that the uplink connection is or poor quality. As the uplink codec mode command is typically updated every 40 ms, it reflects the uplink quality (as seen by the base station transceiver) with little delay.

The following description will describe embodiments of the present invention in which the mobile station uses the codec commands received from the base station as an indication of uplink quality. However, it should be understood that this is for the purposes of example only. The present invention is not limited to any specific methods by which a mobile station may determine the quality of the radio link with a base station, but is intended to encompass implementations using any suitable methods for determining link quality.

In general terms, the power control method according to embodiments of the present invention may be realised by reducing the transmit power for packet-switched and circuit-switched connections equally when a low rate speech codec is not used, and by implementing uplink power prioritisation for the circuit-switched connection when the n lowest rate codec modes of the active codec set are used. This power control method can be understood by considering a specific example in which a mobile station has an active codec set of two (e.g. TCH/AFS 12.2 and 4.75 codecs).

The mobile station in this example is a GSM850/900 of power class 2 with DTM capability. The mobile station has a maximum nominal power output of 2 W (33 dBm) and is transmitting on two GMSK (Gaussian minimum shift keying) timeslots. One of the timeslots is used for packet data and the other is used for circuit-switched data. Initially, the mobile station is instructed to use the 12.2 codec, indicating that the signal quality is good. Therefore, the transmit power for both the circuit-switched connection and the packet-switched connection is reduced by 2 dBm (to account for two timeslots being used). Both connections are transmitted using an output power of 31 dBm and the average output transmit power of the mobile station is 315 mW. Subsequently, the mobile station is instructed by the mobile station to change to the 4.75 codec. The mobile station uses the codec command from the base station as an indication of link quality and determines from the command that the link quality is poor. The mobile station then implements the power prioritisation scheme by increasing the transmit power of the circuit-switched connection to the maximum transmit power for the mobile station (33 dBm). The transmit power of the packet-switched connection is correspondingly reduced to 27.2 dBm, in order to maintain the average transmit power of the mobile station at 315 mW.

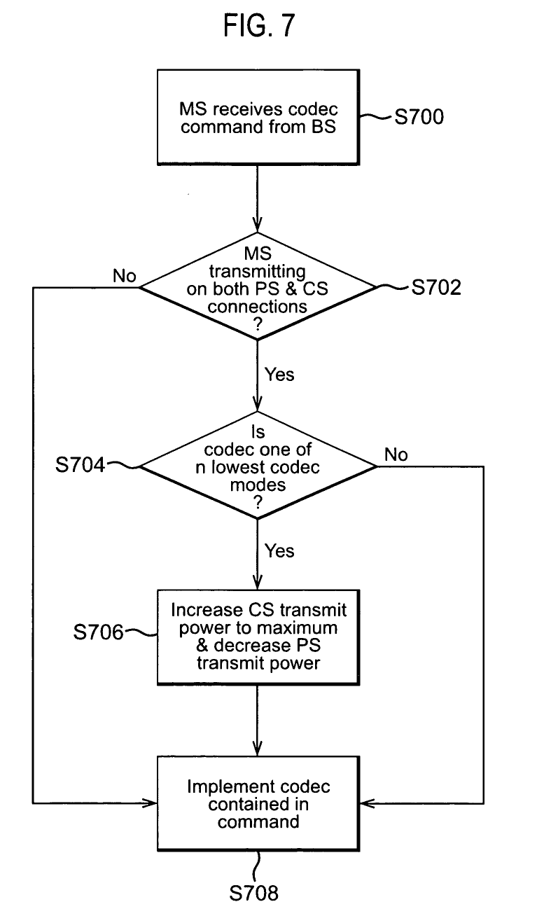

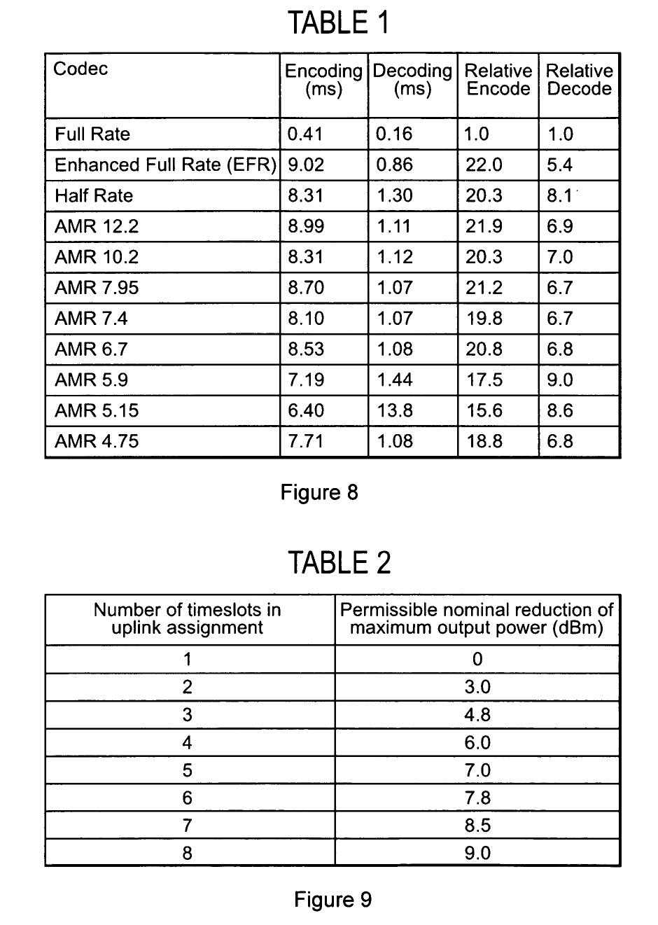

A method of power control according to embodiments of the present invention is illustrated in FIG. 7. In step S700 the mobile station receives a codec command from the base station. In step S702, the mobile station checks whether it is transmitting both a circuit-switched and a packet-switched connection. If not, the mobile station proceeds to step S708 and implements the codec contained in the codec command. If yes, the method proceeds to step S704 in which the mobile station checks whether the codec is one of the n lowest codec modes. If not, the method proceeds to step S708 and implements the codec contained in the codec command. If yes, the mobile station prioritises the transmit power of the circuit-switched connection, increasing it to the maximum transmit power for the mobile station, and reducing the transmit power of the packet-switched connection so as to maintain the average transmit power of the mobile station (step S706). The method then proceeds to step S708, as before, in which the mobile station implements the codec contained in the codec command.

The codec command received from the base station may instruct the mobile station to use a specific codec for encoding transmissions over both the circuit-switched connections and the packet-switched connections or over the circuit-switched connections or packet-switched connections only. Preferably, the codec command instructs the mobile station to use a specific codec for a circuit-switched connection, so that the mobile station can directly derive an indication of signal quality for the circuit-switched connection from the codec it has been instructed to use.

Although in step S708 of FIG. 7 the transmit power for the circuit-switched connection is increased to the maximum transmit power in response to the command to use one of the set of n lowest rate codecs, the transmit power for the circuit-switched connection may actually be increased in stages as the codec commands from the base station indicate that the signal quality is gradually deteriorating. For example, if the mobile station has multiple codecs in its active codec set (e.g. preferably more than two), then the transmit power allocated to the circuit-switched connection may be increased in monotonic steps (up to the maximum transmit power for the mobile station) as the mobile station is commanded to use lower and lower rate codecs from the active codec set. The transmit power allocated to the packet-switched connection may be reduced in similar stages, in order to maintain the average transmit power of the mobile station. The mobile station may similarly increase the transmit power for the circuit-switched connection in unequal steps, e.g. in increasing steps as the signal quality deteriorates. Alternatively, the mobile station may have access to a look-up table containing the n lowest rate codecs from the active set and corresponding transmit power levels for the circuit-switched and packet-switched connections for each of those codecs.

Embodiments of the present invention are advantageously implemented when the mobile station is transmitting the circuit-switched and packet-switched connections at the maximum permitted transmit power for the number of timeslots being used by the mobile station. Although the mobile station may implement a preferential power allocation scheme when transmitting below the maximum power level for the number of timeslots being used, it is undesirable to reduce the transmit power of the packet-switched connection unless absolutely necessary i.e. to enable the transmit power level of the circuit-switched connection to be increased beyond the restricted level.

In addition to implementing a power prioritisation scheme when the signal quality of a connection deteriorates, the mobile station may reverse that prioritisation when the signal quality improves. So, for example, in the specific example discussed above, if the mobile station receives a further codec command from the base station instructing it to change back to the 4.75 codec, the mobile station determines that the signal quality is no longer poor (e.g. because the mobile station has moved away from the cell boundary) and the transmit power of the circuit-switched connection is reduced back to 31 dBm. The transmit power of the packet-switched connection may then be restored back to 31 dBm.

The method of power allocation according to embodiments of the present invention therefore enables a circuit-switched connection to be maintained when radio link quality is poor, for example, at cell boundaries. In order that the packet-switched throughput is not compromised more than is necessary, the circuit-switched power is preferably only prioritised in order to maintain the circuit-switched connection. Therefore, the mobile station only implements a power prioritisation scheme when it determines that the signal quality of the radio link has deteriorated. There are various different methods by which the mobile station may determine that the quality of the radio link has deteriorated, as described above, but a particularly advantageous method is achieved by using the codec commands transmitted by the base station. According to this embodiment of the invention, the mobile station implements a power prioritisation scheme when the codec command instructs the mobile station to use one of a set of n lowest rate codec modes (where n is greater than or equal to one). The mobile station according to this embodiment preferably has an active codec set comprising at least two codec modes. Although the packet-switched connection does suffer from the reduced power allocation it receives when the prioritisation scheme is being implemented by the mobile station, it is advantageous for the packet-switched connection that the circuit-switched connection be maintained, as the packet-switched connection would also be released in the event that the circuit-switched connection was released.

The codecs are preferably speech codecs, but could be other forms of codecs such as video codecs.

Although the above description has referred exclusively to timeslots when describing connections between a mobile station and a base station it should be understood that the present invention is not limited to connections implemented by allocating timeslots. The present invention may be implemented in any communication system in which connections are allocated between a base station and a mobile station e.g. via FDMA, TDMA, CDMA, multi-frames etc.

The present invention has been described in relation to a mobile station and a base station. However, the present invention is not limited to mobile phone networks but may be implemented in any suitable communications network e.g. Bluetooth (RTM) systems.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

What is claimed as new and desired to be protected by Letters Patent of the United States is:

1. A communication system comprising:
a communication station for communicating with another communication station via at least two communications connections, the communication station being arranged to allocate transmit power to each of the at least two connections in dependence on connection quality, the communication station being arranged to:
transmit data over a connection of a first type with a first transmit power level and transmit data over a connection of a second type with a second transmit power level;
derive an indication of connection quality;
determine if the connection quality is below a predetermined quality level; and
in response to the connection quality being below the predetermined quality level, preferentially allocate transmit power to the connection of the first type.

2. A communication system as claimed in claim 1, wherein the connection of the first type is a circuit-switched connection.

3. A communication system as claimed in claim 1, wherein the connection of the second type is a packet-switched connection.

4. A communication system as claimed in claim 1, wherein the communication station is arranged to decrease the transmit power of the connection of the second type in response to the connection quality being below the predetermined quality level.

5. A communication system as claimed in claim 4, wherein the communication station is arranged to decrease the transmit power of the connection of the second type in response to the connection quality being below the predetermined quality level so as to maintain the total transmit power level of the communication station at or below a set level.

6. A communication system as claimed in claim 1, wherein the communication station comprises an active codec set comprising at least two codecs, the communication station being arranged to encode data to be transmitted using a codec contained in the active codec set prior to transmitting the encoded data over a connection.

7. A communication system as claimed in claim 1 and further comprising a controller for setting both the first transmit power level and the second transmit power level to be less than the transmit power level used for transmitting data over a single connection when the communication station is communicating with another communication station via only that connection.

8. A communication system as claimed in claim 7, wherein the controller is arranged to set the total transmit power level of the communication station.

9. A communication system as claimed in claim 7, wherein the communication station comprises an active codec set comprising at least two codecs, the communication station being arranged to encode data to be transmitted using a codec contained in the active codec set prior to transmitting the encoded data over a connection and the controller is arranged to instruct the communication station to use a respective one of the codecs contained in the active codec set for encoding the data to be transmitted.

10. A communication system as claimed in claim 9, wherein the communication station is arranged to derive an indication of connection quality from the respective codec such that the connection quality is determined to be below the predetermined quality level if the respective codec is contained in a predetermined subset of the active codec set.

11. A communication system as claimed in claim 9, wherein the predetermined subset of the active codec set comprises the n lowest rate codecs of the active codec set, where n is a number less than the total number of codecs contained within the active codec set.

12. A communication system as claimed in claim 11, wherein n is 1.

13. A communication system as claimed in claim 7, wherein the controller is contained within the communication station.

14. A communication system as claimed in claim 7, wherein the controller is external to the communication station.

15. A method for allocating transmit power in a communication station, the communication station being arranged to communicate with another communication station via at least two communications connections and being arranged to allocate transmit power to each of the at least two connections in dependence on connection quality, the method comprising:
transmitting data over a connection of a first type with a first transmit power level and transmitting data over a connection of a second type with a second transmit power level;
deriving an indication of connection quality;
determining if the connection quality is below a predetermined quality level; and
in response to the connection quality being below the predetermined quality level, preferentially allocating transmit power to the connection of the first type.
